(19) United States
(12) Patent Application Publication
(10) Pub. No.: US 2003/0118900 A1
(43) Pub. Date: Jun. 26, 2003

(54) Non-aqueous electrolyte battery

(75) Inventor: Makihiro Otohata, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/321,485

(22) Filed: Dec. 18, 2002

(30) Foreign Application Priority Data
Dec. 21, 2001 (JP) 2001-390693

(51) Int. Cl. H01M 2/02; H01M 2/08; H01M 10/04

(52) U.S. Cl. 429/162; 429/185; 29/623.2; 29/623.4

(57) ABSTRACT

A non-aqueous electrolyte battery has a laminate housing encapsulating therein a battery body including an anode, a cathode and an electrolyte. The laminate housing is made of two laminated films which are thermally fused together at the edge portions thereof. The thermally fused edge portions encapsulate therein moisture absorbent, which is separated from the battery body for effectively preventing the ingress of water.

### BACKGROUND OF THE INVENTION

(a) Field of the Invention

The present invention relates to a non-aqueous electrolyte battery and, more particularly, to a non-aqueous electrolyte battery which is capable of effectively preventing ingress of water inside the battery housing. The present invention also relates to methods for manufacturing such a non-aqueous electrolyte battery

(b) Description of the Related Art

A conventional battery, or battery cell has a housing can made of a metal for encapsulating therein a battery body including an anode, a cathode and an electrolyte. For achieving lighter weight and smaller dimensions as well as a variety of shapes for the battery, a laminated film structure has been increasingly used as the housing for the battery. The laminated film structure or laminate housing generally includes a metallic layer or metallic foil made of aluminum, and a pair of thermo-fusing resin layers including an inner nylon layer and an outer polyethylene or polypropylene layer. After the laminate housing receives therein the battery body through an opening of the laminate housing, the opening is thermally fused to form an encapsulating structure. Although some of non-aqueous electrolyte batteries such as a lithium-ion secondary battery have been suffered from degradation of battery characteristics due to ingress of external water inside the battery cell, such a degradation is prevented by using the metallic layer in the laminate housing for prevention of the ingress of water while achieving a smaller thickness of the battery cell.

In the structure of the laminate housing, since the thermo-fusing resin layer such as a polyethylene layer or a polypropylene layer passing water therethrough is exposed on the external surface of the battery cell, water may gradually enter the battery cell through the laminate housing along the sealing structure of the thermo-fusing resin layer, thereby degrading the long-term reliability of the battery.

For reducing the amount of water entering the battery cell, it is generally effective to increase the path length for the water at the sealing structure of the thermo-fusing resin film. However, a large path length generally increases the planar size of the thin battery cell, thereby canceling the advantage of the smaller dimensions of the battery cell achieved by the laminate housing.

Patent Publications JP-A-11-297280, -2000-251855 and -2001-60453 describe battery cells each including a laminate housing structure wherein the edge of the laminate housing is folded for achieving a sealing structure having a larger path length for water without increasing the planar size of the battery cells. In the described structure, a single folded section of the sealing structure is expected to increase the path length of the sealing structure by two times while maintaining the planar size of the battery size. That is, the amount of external water entering the battery body may be reduced to half at most by the single folded section. It is substantially impossible to increase the number of the folded sections for reducing the amount of water to a negligible extent without increasing the planar size of the battery cell.

Patent Publications JP-A-11-40114 and -2000-251854 describe battery cells each having a laminate housing, wherein an additional resin film is provided for covering the internal sealing structure to increase the sealing capability. In such a structure, however, external water may enter the battery cell along the additional resin film. That is, although the addition of the resin film may increase the effective path length by about 1.5 times at most, a remarkable effect of prevention of the ingress of external water cannot be expected.

Patent Publication JP-A-2000-223090 describes a battery cell having a laminate housing, wherein a metallic layer is provided as an external layer with the thermo-fusing resin layer being the internal layer. In this structure, the metallic layer is sealed by welding together the edges of the metallic layer, to prevent the ingress of water. This structure may be effective if all the external surface of the battery cell is covered with the metallic layer. However, it is difficult to apply this welding structure to a laminated film structure having resin/metallic/resin layers.

Patent Publications JP-A-2000-243357 and -11-307131 describe battery cells each having a laminate housing receiving therein a moisture absorbent together with the battery body. In this structure, however, part of water entering the battery cell may be reacted with the electrolyte before being absorbed by the moisture absorbent, thereby degrading the battery characteristics.

### SUMMARY OF THE INVENTION

In view of the above problems in the conventional techniques, it is an object of the present invention to provide a non-aqueous electrolyte battery having a laminate housing which is capable of effectively protecting the battery body against the external water entering the battery cell.

It is another object of the present invention to provide methods for manufacturing such a non-aqueous electrolyte battery.

The present invention provides a non-aqueous electrolyte battery including a battery body having a cathode, an anode and a non-aqueous electrolyte, a laminate housing having a thermally fused periphery for encapsulating the battery body within the laminate housing, and a moisture absorbing member disposed along the thermally fused periphery in a spaced relationship with the battery body.

The present invention also provides a method for manufacturing a non-aqueous electrolyte battery including the steps of: sandwiching a battery body including a cathode, an anode and an electrolyte between a pair of laminated films; overlapping edge portions of the laminated films together while sandwiching a moisture absorbing member between the overlapped edge portions; and fusing the overlapped edge portions to form a sealing structure encapsulating therein the moisture member and sealing a laminate housing encapsulating therein the battery body.

The present invention further provides a method for manufacturing a non-aqueous electrolyte battery including the steps of: sandwiching a battery body including a cathode, an anode and an electrolyte between folded parts of a laminated film; overlapping edge portions of the folded parts at three sides thereof while sandwiching a moisture absorbing member between the overlapped edge portions of at least one of the three sides; and fusing the overlapped edge portions to form a sealing structure encapsulating therein the moisture member and sealing a laminate housing encapsulating therein the battery body.

The present invention further provides a method for manufacturing a non-aqueous electrolyte battery including the steps of: sandwiching a battery body including a cathode, an anode and an electrolyte between a pair of laminated films; overlapping edge portions of the laminated films together and fusing the overlapped edge portions to form a laminate housing encapsulating therein the battery body; extending a moisture absorbing member along the fused overlapped edge portions; and covering the moisture absorbing member by using a stripe film.

In accordance with the battery of the present invention and the batteries manufactured by the methods of the present invention, the ingress of external water is effectively prevented by the moisture absorbing member while preventing the external water from contacting the battery body due to the spaced relationship between the moisture absorbing member and the battery body.

The above and other objects, features and advantages of the present invention will be more apparent from the following description, referring to the accompanying drawings.

### BRIEF DESCRIPTION OF THE DRAWINGS

FIG. 1 is a perspective view of a first embodiment of the laminate housing according to the present invention.

FIG. 2 is sectional view of the sealing structure of the laminate housing of FIG. 1 FIG. 3 is a sectional view of the sealing structure of FIG. 2 after folding thereof.

FIG. 4 is a perspective view of a second embodiment of the laminate housing according to the present invention.

FIG. 5 is a sectional view of the sealing structure of the laminate housing of FIG. 4.

FIG. 6 is a perspective view of a modification of the laminate housing of FIG. 1.

FIG. 7 is a perspective view of another modification of the laminate housing of FIG. 1.

FIG. 8 is a perspective view of another modification of the laminate housing of FIG. 1.

FIG. 9 is a perspective view of another modification of the laminate housing of FIG. 1.

FIG. 10 is a sectional view of the sealing structure of a third embodiment of the laminate housing according to the present invention.

FIG. 11 is a sectional view of a modification of the sealing structure a third embodiment of the laminate housing according to the present invention.

FIG. 12 is a perspective view of a fourth embodiment of the laminate housing according to the present invention, showing a first embodiment of the non-aqueous electrolyte battery according to the present invention.

FIG. 13 is a sectional view of the sealing structure of the laminate housing of the battery FIG. 12.

FIG. 14 is a sectional view of the sealing structure of the battery according to the present invention.

FIG. 15 is a perspective view of a second embodiment of the non-aqueous electrolyte battery according to the present invention.

FIG. 16 is a perspective view of a third embodiment of the non-aqueous electrolyte battery according to the present invention.

FIG. 17 is a perspective view of a modification of the battery of FIG. 16.

FIG. 18 is a perspective view of another modification of the battery of FIG. 16.

FIG. 19 is a perspective view of a fourth embodiment of the non-aqueous electrolyte battery according to the present invention.

FIG. 20 is a sectional view of the sealing structure of the battery of FIG. 19.

FIG. 21 is a perspective view of a fifth embodiment of the non-aqueous electrolyte battery according to the present invention of the present invention.

FIG. 22 is a sectional view of the sealing structure of the fifth embodiment of FIG. 21.

FIG. 23 is a perspective view of a sixth embodiment of the non-aqueous electrolyte battery according to the present invention.

### PREFERRED EMBODIMENTS OF THE INVENTION

Now, the present invention is more specifically described with reference to accompanying drawings, wherein similar constituent elements are designated by similar reference numerals for omitting a duplicated description thereof.

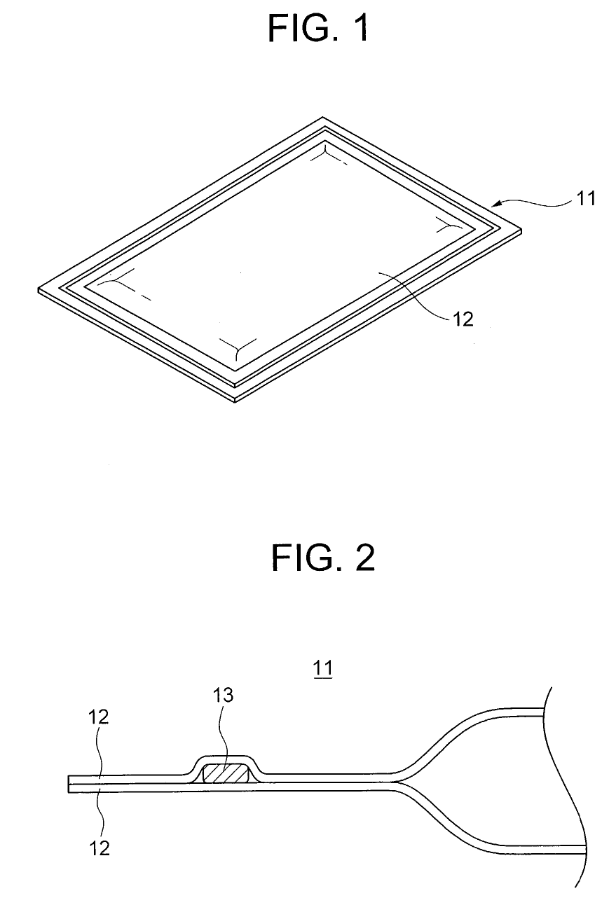

Referring to FIG. 1, a laminate housing, generally designated by numeral 11, according to a first embodiment of the present invention is formed as a shape of housing bag, and used for receiving therein a battery body of a non-aqueous electrolyte secondary battery. The laminate housing 11 includes a pair of laminated films 12, wherein the edge portions of the pair of laminated films 12 are bonded together by a thermally fusing process for forming a sealing structure. The laminated film 12 includes at least two layers including a metallic layer and a thermo-fusing resin layer, and preferably includes three layers including a metallic layer and a pair of thermo-fusing resin layers sandwiching therebetween the metallic layer.

The metallic layer may be made of a known metal or alloy such as aluminum, stainless steel, nickel and copper, having a function for stopping the ingress of external water.

The thermo-fusing resin film may be made of known resin such as polypropylene, polyethylene, and a polyethyleneterephthalate, having a function for encapsulating or sealing therein the battery body by thermally fusing the resin.

Referring to FIG. 2 showing the periphery of the laminate housing 11, the sealing structure of the laminate housing 12 includes edge stripe portions of the pair of laminated films 12 thermally fused together, and a moisture absorbing member or moisture absorbent 13 extending along and sandwiched between the edge stripe portions of the laminated films 12 and sealed within the edge stripe portions of the laminated films 12 which are thermally fused together. The sealing structure seals the laminate housing 11 encapsulating therein the battery body.

The moisture absorbent 13 may be selected from a known material having a function for absorbing water or moisture. Examples of the moisture absorbent 13 includes inorganic moisture absorbent such as synthetic zeolite and silica gel, a high-water-absorption-capability resin group having a function for chemically absorbing water, such as sodium acrylate resin, and other moisture absorbents such as phosphorous pentoxide, barium oxide and calcium oxide. The positioning of the moisture absorbent 13 within the edge stripe portions is preferably performed by using an adhesive tape, adhesive resin layer or depression, which is attached or formed on one of the edge stripe portions of the laminated film 12, as by coating, thermally pressing or drawing.

Referring to FIG. 3, a modification of the first embodiment includes a sealing structure of the laminate housing 11 wherein the periphery of the thermally fused edge stripe portions is folded onto the inner portion of the thermally fused edge stripe portions while crossing over the moisture absorbent 13. The number of folding section may be one or more. This folding structure further reduces the planar size of the laminate housing 11.

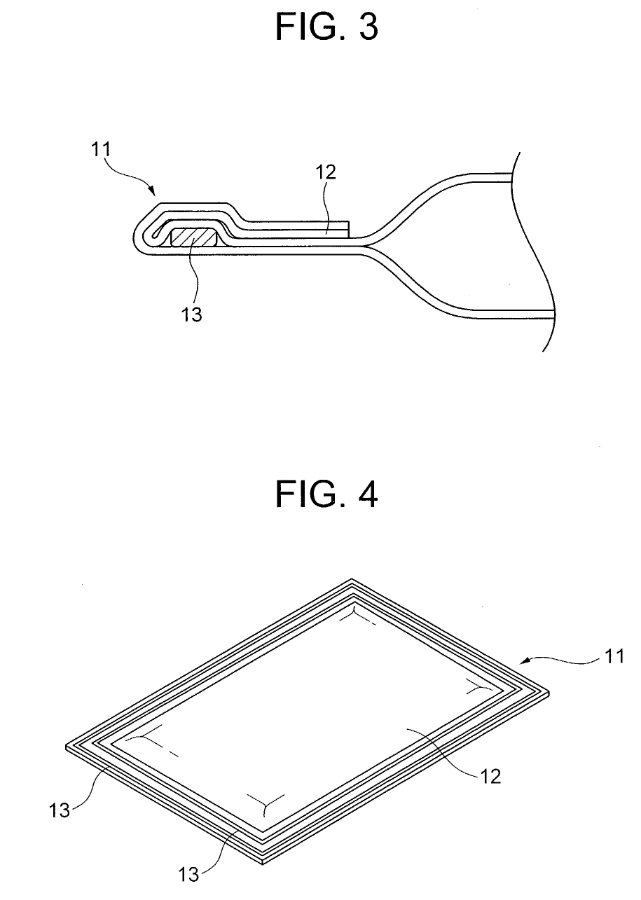

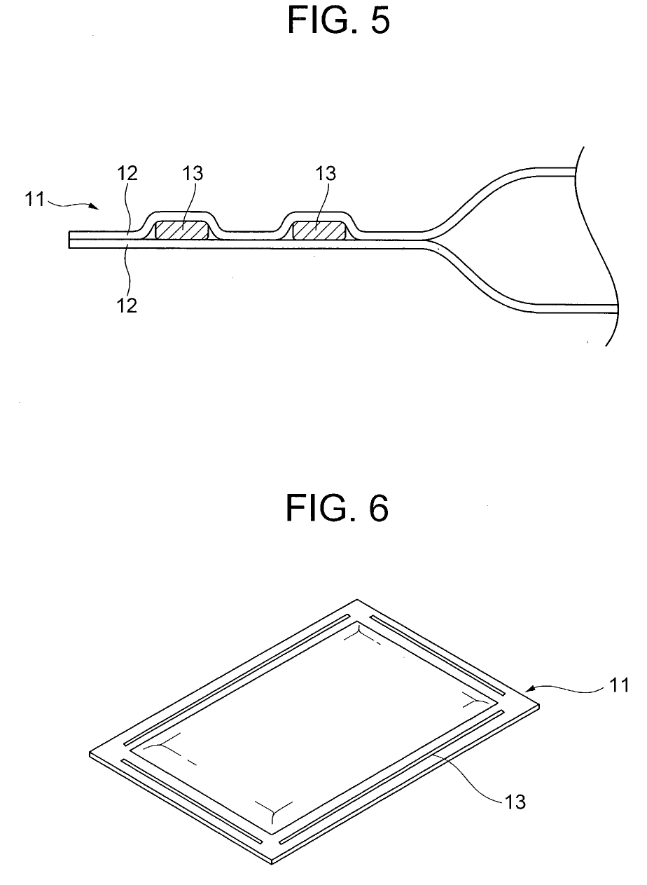

Referring to FIGS. 4 and 5, a laminate housing 11 according to a second embodiment of the present invention includes has a sealing structure wherein the moisture absorbent 13 extends in a pair of rows along the outer periphery of the laminated films 12 and is sandwiched between the edge stripe portions of the thermally-fused laminated films 12. The moisture absorbent 13 may extend in three or more rows along the outer periphery of the laminate housing 11.

Referring to FIGS. 6 to 9, there are shown several modifications of the arrangement of the moisture absorbent 13. In the modification shown in FIG. 6, the moisture absorbent 13 is omitted at the four corner portions of the laminate housing 11. This sealing structure is employed in view of the reasons described hereinafter. The moisture absorbent 13 generally absorbs water in the external air to gradually reduce its capability of absorbing water. The water may enter the laminate housing 11 before or after being absorbed by the moisture absorbent 13, and may be reacted with chemicals inside the battery body, if the moisture absorbent is communicated with the battery body inside the laminate housing 11.

Thus, communication of the moisture absorbent 13 and the battery body or external air should be avoided as by accurately covering the moisture absorbent 13 by the laminated films 12 at all the surface of the moisture absorbent 13. This may be achieved by an accurate arrangement of the moisture absorbent 13. During the step for thermally fusing the peripheries of the laminated films 12 overlapped each other, the four sides of the rectangular laminated films 12 are fused separately. In such a process, each corner portion of the laminate housing 11 is subjected to the thermal fusion for two times, which may cause a deviation of the moisture absorbent 13 from the fused portions during the thermal process. The prevention of deviation of the moisture absorbent 13 necessitates a more accurate arrangement of the corner portions of the moisture absorbent 13, or such a deviation may be avoided by removing the moisture absorbent 13 at the corner portion. The present embodiment is employed in view of the latter.

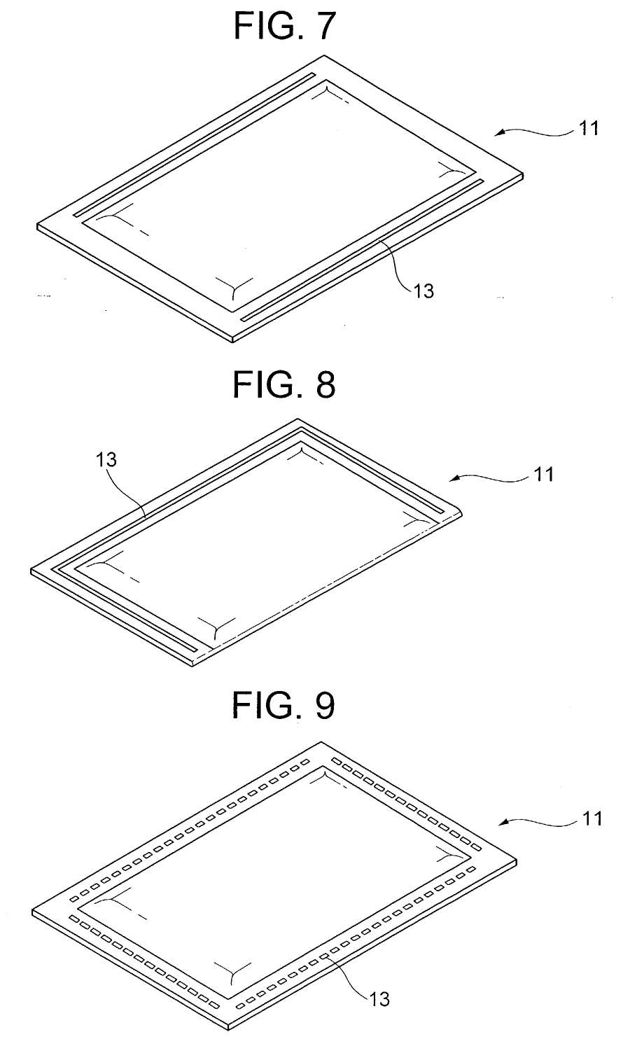

In the modification shown in FIG. 7, only two longer sides of the rectangular laminate housing 11 are provided with the moisture absorbent 13. In the modification shown in FIG. 8, the laminate housing 11 is formed by folding a single laminated film 12 at the central line thereof, wherein three sides of the folded laminate film 12 are provided with the moisture absorbent 13, with the remaining side being formed by the folded section which is not provided with the moisture absorbent.

In the modification shown in FIG. 9, the moisture absorbent 13 is disposed intermittently at a specified constant interval, similarly to the shape of a doted line. The space between adjacent moisture absorbent portions should be determined in consideration of the property of the absorbent 13 and the strength of the sealing structure of the laminated films 12.

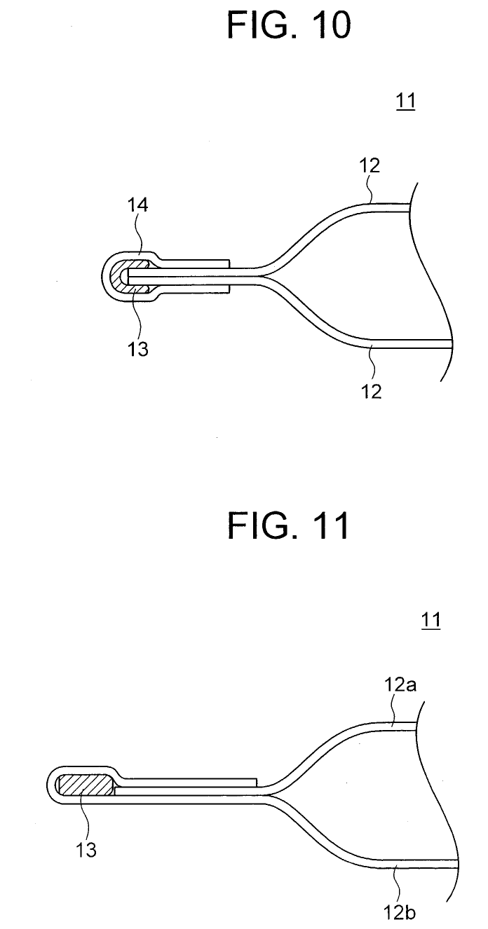

Referring to FIG. 10, the sealing structure of a laminate housing 11 according to a third embodiment of the present invention is such that the moisture absorbent 13 is disposed outside the overlapped edge portions of the laminated films 12, with an additional stripe film 14 covering the moisture absorbent 13. The additional stripe film 14 is preferably made of a metallic material or a laminated film similar to the laminated housing 11 including a metallic layer. In the present embodiment, a larger design choice can be obtained for the amount, shape or arrangement of the moisture absorbent 13.

In the modification shown in FIG. 11, the edge portion of one (12a) of the laminated films 12 is disposed outside the edge portion of the other (12b) of the laminated films 12, the edge portion of the laminated film 12a being folded and bonded onto the edge portion of the laminated film 12b to encapsulate therebetween the moisture absorbent 13. The bonding may be preferably performed by thermal fusing. In this configuration, the positioning of the moisture absorbent 13 is performed by alignment thereof along the edge portion of the laminated film 12b, that is, by using the step difference between the edge portions of the laminated films 12a and 12b.

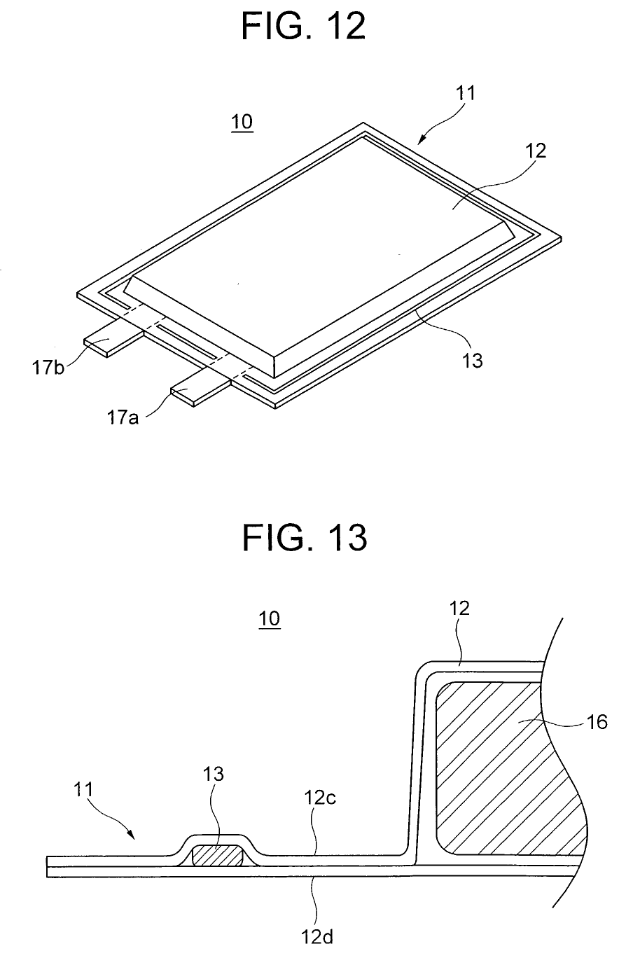

Referring to FIGS. 12 and 13, a laminate housing 11 according to a fourth embodiment of the present invention is shown together with the battery body of a non-aqueous electrolyte battery 10. The battery 10 includes a cathode electrode lead 17a and an anode electrode lead 17b both extending from the battery body 16 encapsulated in the laminate housing 11. The battery body 16 includes a non-aqueous electrolyte, which is generally degraded in the battery characteristics by the ingress of external water and thus protected by the sealing structure of the laminate housing 11 of the present embodiment. The battery 10 may be lithium polymer battery, lithium ion battery or lithium metal battery, and may be a primary battery or a secondary battery.

As shown in FIG. 13, one (12a) of the laminated films 12 has a depression formed on the central portion of the laminated film 12a by a deep drawing process for receiving therein the battery body 16. The laminated film 12b has a flat surface on which the moisture absorbent 13 is arranged at the edge portion, followed by covering the moisture absorbent 13 by the edge portion of the laminated film 12a having the depression. The moisture absorbent 13 is located substantially at the center of the thermally fused edge portions, and thus covered at the entire surface thereof by the thermally fused edge portions.

In the present embodiment, the moisture absorbent 13 is not provided in the vicinity of the electrode leads 17a and 17b for allowing the electrode leads 17a and 17b to pass through the sealing structure. The structures of the laminated films 12 used in the second and third embodiments may be used in the present embodiment.

The battery shown in FIGS. 12 and 13 is a first embodiment of the non-aqueous electrolyte battery 10 according to the present invention. The actual process used for manufacturing the first embodiment of the non-aqueous electrolyte battery 10 is described hereinafter.

The cathode active material of the battery body was made from a mixture of powdery lithium manganese oxide having a spinel structure, carbon-containing conductive agent, and polyfluoridevinylidene, which were mixed at a ratio of 90:5:5 in the recited order. These substances were dispersed in a solvent, N-methyl-2-pyrolidone (NMP), and stirred for well mixing to form a slurry of the cathode active material. The amount of the solvent was adjusted so that the slurry had a suitable viscosity.

The resultant slurry was applied onto a surface of a 20-μm-thick aluminum foil, or cathode collector, by a coating process using a doctor blade. The coating process was such that a plurality of stripe non-coat areas appeared for exposing the surface of the cathode collector. The slurry applied on the collector was subjected to baking or drying in a vacuum ambient at a temperature of 100 degrees C. for two hours. Thereafter, the slurry was also applied to the other surface of the collector and subjected to the baking in the vacuum ambient similarly. Each of the stripe non-coat areas on the top surface and a corresponding stripe non-coat area on the bottom surface of the collector were disposed to oppose each other. The resultant sheet was then subjected to a roll-press process and then cut into a plurality of rectangular plates each coated with the active material on both sides thereof, with a stripe non-coat area being disposed at the periphery thereof. A portion of the stripe non-coated area was then removed by cutting to leave the remaining portion as an electrode lead.

A micro-porous separator was formed having the following three-layer structure:

polypropylene/polyethylene/polypropylene and having a rectangular planar size somewhat larger than the rectangular planar size of the electrode plate. The electrode plate was then sandwiched between a pair of separators thus obtained. The edges of the separators were bonded by a thermally fusing equipment at three sides of the separators excepting the side on which the electrode leads were formed, whereby a cathode plate received in a separator bag was obtained.

The anode active material was obtained by dispersing powdery amorphous carbon and polyfluoridevinylidene in a solvent, NMP, at a weight ratio of 91:9, and mixing and stirring these substances to form a slurry. The amount of NMP was adjusted to obtain a suitable viscosity for the slurry. The resultant slurry was applied onto a surface of a 10-μm-thick copper plate, or an anode collector, by a coating process using a doctor blade. The coating process was such that a plurality of non-coat areas appeared for exposing the anode collector. The anode active material on the anode collector was baked in a vacuum ambient at a temperature of 100 degrees C. for two hours.

The thickness of the anode active material was adjusted so that the ratio of the theoretical capacity per unit area of the anode layer to the theoretical capacity per unit area of the cathode layer assumed 1:1. Similarly, the other surface of the anode collector was coated by the anode active material and baked in a vacuum ambient. Each of the stripe non-coat areas on the top surface and a corresponding stripe non-coat area on the bottom surface of the collector were disposed to oppose each other. The resultant sheet was then subjected to a roll-press process, and cut into an anode plate having a planar size larger than the planar size of the cathode plate by 2 mm at each side of the plate. A portion of the stripe non-coated area was then removed by cutting to leave the remaining portion as an electrode lead.

A plurality of cathode plates and a plurality of anode plates, each manufactured as described above and received in a separator bag, were alternately stacked one on another, thereby obtaining a stacked battery body wherein anodes were disposed second outermost sides of the battery body, with the separators being disposed outermost sides of the body, i.e., separator/anode/separator/cathode/separator . . . /anode/separ ator body structure was obtained. The electrode leads of the cathode plates were bonded together to an aluminum electrode by an ultrasonic bonding technique, whereas the electrode leads of the anode plates were bonded together to a nickel electrode by an ultrasonic bonding technique.

A pair of aluminum laminated films each having a three-layer structure including

nylon/aluminum/polypropylene were prepared, and one of these laminated films was subjected to a deep drawing process whereby the surface of the polypropylene had a depression for receiving therein the battery body. A moisture absorbent sheet wherein zeolite was dispersed into resin was cut into a stripe, and then fixed by using an adhesive tape onto the central portion of the thermally fusing portion of the polypropylene surface of the aluminum laminated film having no depression thereon.

The moisture absorbent sheet was disposed at the location other than the location at which the electrode leads of the anode and cathode cross the thermally fusing portion. The fixing of the moisture absorbent sheet may be effected by an adhesive layer, or by direct application or thermal fusing onto the surface of the aluminum laminated film. Such a fixing may be assisted or conducted by forming another depression on the surface of the laminated film by a deep drawing technique.

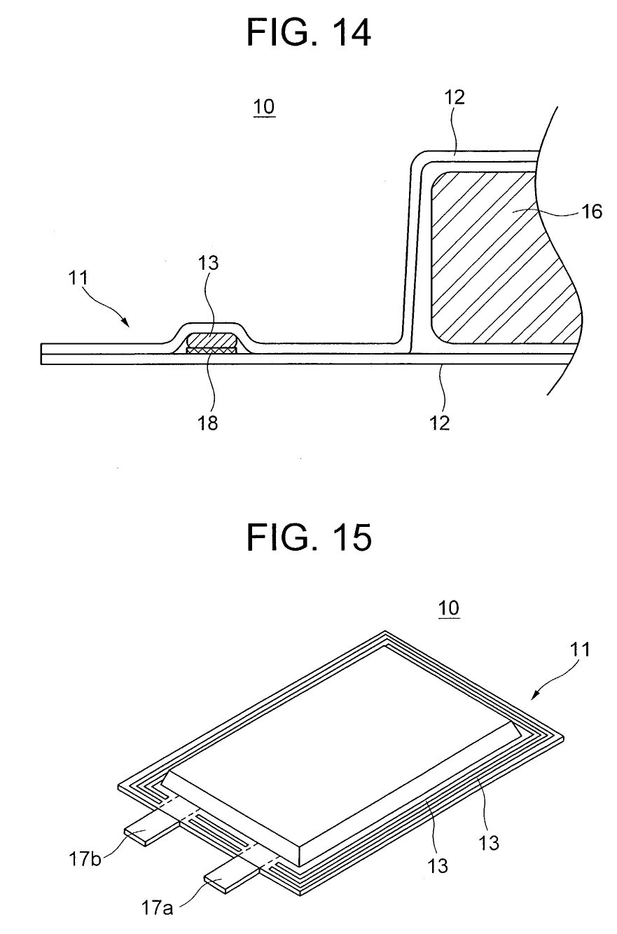

The battery body was then received in the central depression of the laminated film so that the aluminum lead electrodes protruded from the laminated film, followed by overlapping the other laminated film onto the laminated film mounting thereon the battery body and thermally fusing the tree sides of the overlapped laminated films. FIG. 14 shows a portion of the structure of the resultant battery, wherein the battery body 16 is received in the laminate housing 11, which is sealed by the sealing structure using the moisture absorbent 13 fixed by the adhesive layer 18 onto the laminate film 12.

An electrolyte was then introduced into the laminate housing 11 through the remaining side not thermally fused. The electrolyte used herein was such that LiPF₆ was used as a support salt, and a mixture of propylene carbonate and ethylene carbonate mixed at a weight ratio of 50:50 was used as a solvent, to which the support salt was mixed at a concentration of 1 mol./liter. After introduction of the electrolyte, the opening of the laminate housing is sealed in a vacuum ambient to obtain a lithium-ion secondary battery having the laminate housing of the present invention.

The resultant lithium-ion secondary battery had excellent battery characteristics due to effective prevention of the ingress of external water inside the laminate housing.

Referring to FIG. 15, a second embodiment of the battery according to the present invention is similar to the first embodiment of the battery except that the moisture absorbent 13 is disposed in two rows along the outer periphery of the laminate housing 11. In a modification of the second embodiment, the moisture absorbent 13 may be disposed in three or more rows for further effective prevention of the ingress of external water.

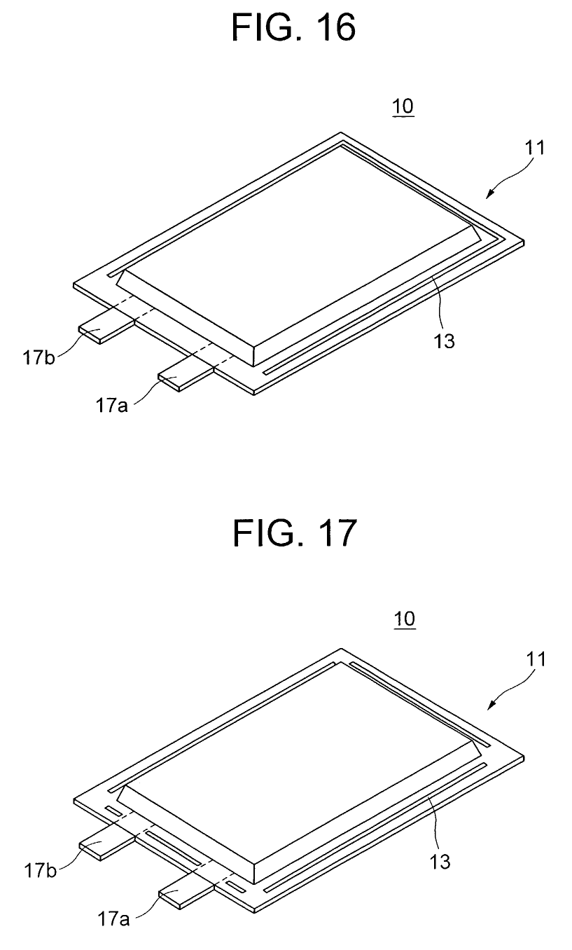

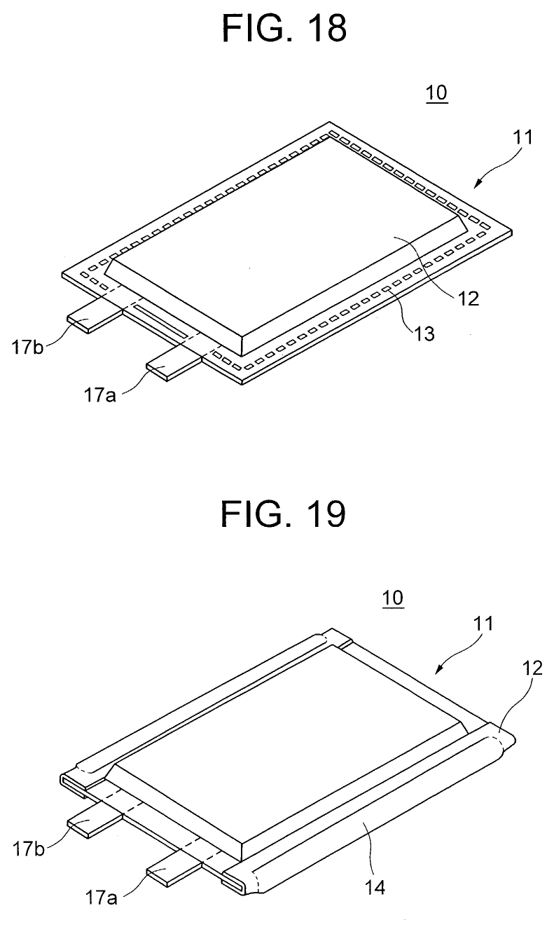

Referring to FIG. 16, a third embodiment of the battery according to the present invention is similar to the first embodiment except that the side through which the electrode leads 17a and 17b extend is not provided with the moisture absorbent 13. The moisture absorbent 13 in the present invention may be disposed on at least one side of the laminate housing. In modifications of the third embodiment, the moisture absorbent may be omitted at the corner portion of the laminate housing 11, as shown in FIG. 17, or may be disposed intermittently at a specified interval, as shown in FIG. 18.

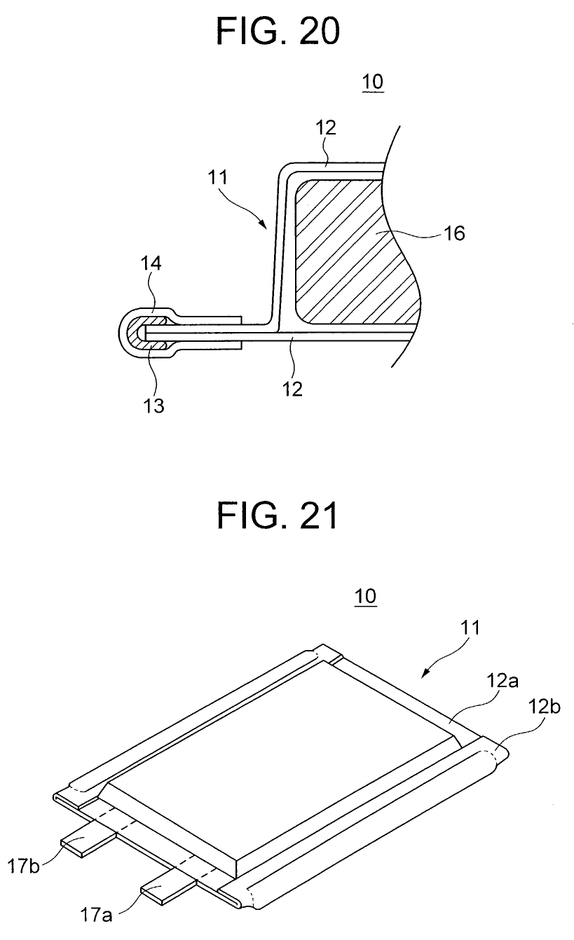

Referring to FIGS. 19 and 20, in a fourth embodiment of the battery according to the present invention, the moisture absorbent 13 is disposed adjacent to the overlapped edge portions of the laminated films 12 only at the longer sides of the rectangular laminate housing 11. The moisture absorbent 13 is covered by a stripe film 14 extending along each longer side of the laminate housing 11 and is folded at the longer side. The stripe film 14 is preferably a laminated film similar to the laminated film of the laminate housing 11.

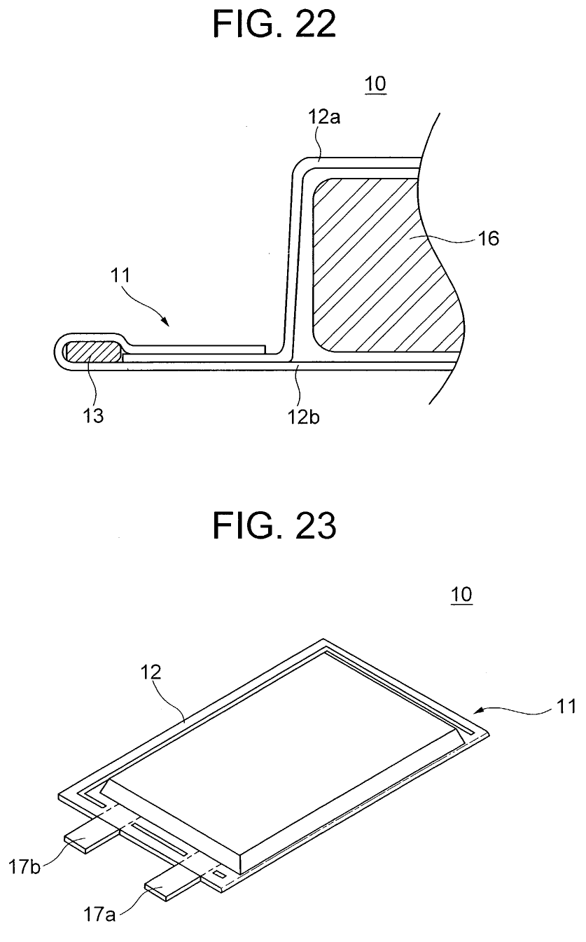

Referring to FIGS. 21 and 22, in a fifth embodiment of the battery according to the present invention, the edges of the longer sides of the bottom laminated film 12b are disposed outside the edges of the longer sides of the top laminated film 12a and are folded onto the edge portions of the longer sides of the top laminated film 12a. The moisture absorbent 13 is covered by the folded edge portions of the bottom laminated film 12a.

Referring to FIG. 23, a sixth embodiment of the battery according to the present invention is similar to the first embodiment except that a single laminated film 12 is used and folded at the central line of the laminated film 12. The edge of the three sides of the laminate housing 11 is thermally fused, whereas the remaining edge of the laminate housing 11 is implemented by the folded side without using the thermal fusing and the moisture absorbent. This structure is preferable due to omission of the moisture absorbent at the folded side.

The present invention is not limited to the exemplified secondary batteries, and may be applied to any type of the battery having a non-aqueous electrolyte or a material which necessitates prevention of the ingress of external water.

Since the above embodiments are described only for examples, the present invention is not limited to the above embodiments and various modifications or alterations can be easily made therefrom by those skilled in the art without departing from the scope of the present invention.

What is claimed is:

1. A non-aqueous electrolyte battery comprising a battery body having a cathode, an anode and a non-aqueous electrolyte for passing electric current between said cathode and anode, a laminate housing having a thermally fused periphery for encapsulating said battery body within said laminate housing, and a moisture absorbing member disposed along said thermally fused periphery in a spaced relationship with said battery body.

2. The non-aqueous electrolyte battery according to claim 1, wherein said moisture absorbing member is encapsulated within said thermally fused periphery of said laminate housing.

3. The non-aqueous electrolyte battery according to claim 1, wherein said moisture absorbing member is disposed outside said thermally fused periphery and covered by a stripe film extending along and bonded onto said thermally fused periphery.

4. The non-aqueous electrolyte battery according to claim 1, wherein said laminate housing includes at least one side formed by a pair of thermally fused edge portions, one of said thermally fused edge portions having a protruding portion protruding from the other of said thermally fused edge portions and folded to cover said moisture absorbing member.

5. The non-aqueous electrolyte battery according to claim 1, wherein said laminate housing includes a pair of laminated films thermally fused together at the outer periphery of said laminate housing.

6. The non-aqueous electrolyte battery according to claim 1, wherein said laminate housing includes a single laminated film folded to form a housing bag.

7. The non-aqueous electrolyte battery according to claim 1, wherein said laminate housing includes a laminated film including a metallic layer and at least one resin layer having a property of being thermally fused.

8. The non-aqueous electrolyte battery according to claim 1, wherein said moisture absorbing member includes synthetic zeolite, silica gel, phosphorous pentoxide, barium oxide and/or calcium oxide.

9. A method for manufacturing a non-aqueous electrolyte battery comprising the steps of:
sandwiching a battery body including a cathode, an anode and an electrolyte between a pair of laminated films;
overlapping edge portions of said laminated films together while sandwiching a moisture absorbing member between said overlapped edge portions; and
fusing said overlapped edge portions to form a sealing structure encapsulating therein said moisture member and sealing a laminate housing encapsulating therein said battery body.

10. A method for manufacturing a non-aqueous electrolyte battery comprising the steps of:
sandwiching a battery body including a cathode, an anode and an electrolyte between folded parts of a laminated film;
overlapping edge potions of said folded parts at three sides thereof while sandwiching a moisture absorbing member between said overlapped edge portions of at least one of said three sides; and
fusing said overlapped edge portions to form a sealing structure encapsulating therein said moisture member and sealing a laminate housing encapsulating therein said battery body.

11. A method for manufacturing a non-aqueous electrolyte battery comprising the steps of:
sandwiching a battery body including a cathode, an anode and an electrolyte between a pair of laminated films;
overlapping edge portions of said laminated films together and fusing said overlapped edge portions to form a laminate housing encapsulating therein said battery body;
extending a moisture absorbing member along said fused overlapped edge portions; and
covering said moisture absorbing member by using a stripe film.

12. The method according to claim 11, wherein said stripe film is a part of one of said fused edge portions extending from said fused overlapped edge portions.
